(19) United States
(12) Patent Application Publication
(10) Pub. No.: US 2013/0025391 A1
(43) Pub. Date: Jan. 31, 2013

(54) Gear Backlash Compensation In A Printing Device

(71) Applicant: Daniel James Magnusson, Vancouver, WA (US)

(72) Inventor: Daniel James Magnusson, Vancouver, WA (US)

(21) Appl. No.: 13/192,042

(22) Filed: Jul. 27, 2011

(51) Int. Cl. F16H 55/18

(52) U.S. Cl. 74/409

(57) ABSTRACT

Example embodiments disclosed herein relate to gear backlash compensation in a printing device. This gear backlash compensation occurs in a gear train assembly utilized to drive and position a service station of the printing device. The gear train assembly is driven by a media advance and positioning subsystem of the printing device.

### BACKGROUND

A challenge exists to deliver quality and value to consumers, for example, by providing reliable printing devices that are cost effective. Further, businesses may desire to enhance the performance of their printing devices, for example, by increasing the accuracy of the functioning of one or more components of such printing devices.

### BRIEF DESCRIPTION OF THE DRAWINGS

The following detailed description references the drawings, wherein:

FIG. 1 shows a perspective view of an example of a printing device.

FIG. 2 shows a perspective view of an example of some of the components of the printing device of FIG. 1 in a first position.

FIG. 3 shows a perspective view of an example of the components of FIG. 2 in a second position.

FIG. 4 is a diagram illustrating an example of some additional components of the printing device of FIG. 1.

FIG. 4a is an enlarged side view of an example illustrating backlash between a pair of adjacent gears.

FIGS. 5a-5d illustrate examples of implementations of targets on a service station.

FIG. 6 is a block diagram and example of a method for use in a printing device.

FIG. 7 is a block diagram and example of additional elements of the method shown in FIG. 6.

### DETAILED DESCRIPTION

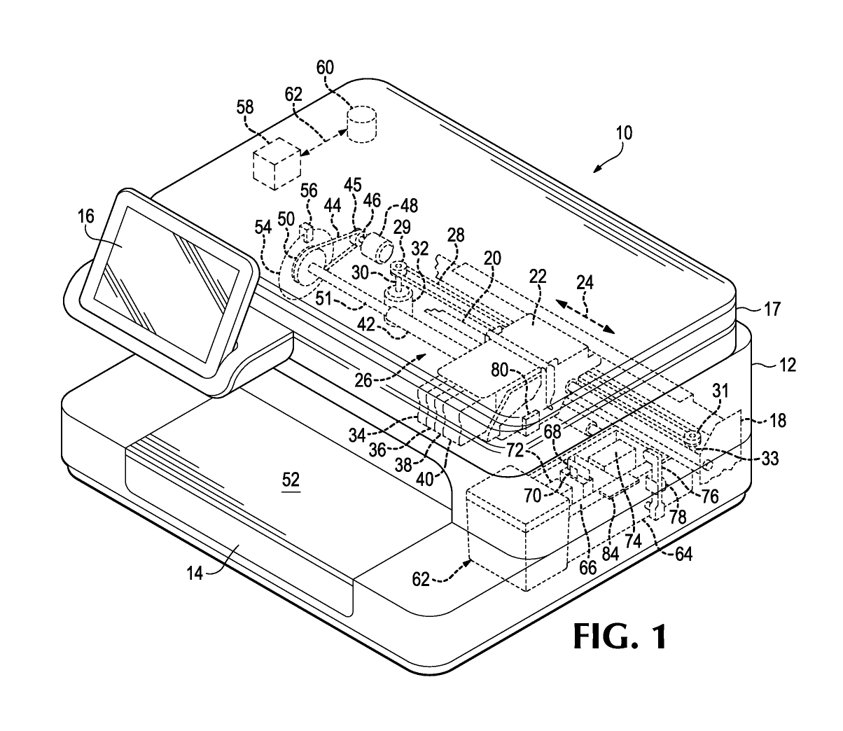

A perspective view of an example of a printing device 10 is shown in FIG. 1. Printing device 10 may be used in the home or office environment and can provide a variety of different outputs such as text and images. The example printing device 10 that is shown in FIG. 1 is a desktop size. However, embodiments of the invention may be used in other sized printing devices, such as floor-standing sized or portable sized models.

Some of the external components of printing device 10 that are shown include a case or housing 12 and a removable tray 14 for holding various sized print media. Printing device 10 also includes a screen 16 that provides information to an end user (such as the status of a particular print job) and may also allow the end user to make selections (i.e., print quality, print media orientation, etc.) regarding configuring the operation of printing device 10. Printer 10 further includes a cover or lid 17 that may be opened by an end user to access internal components of printing device 10.

One of the internal components of printing device 10 that is shown is a frame or chassis 18. Frame or chassis 18 helps provide support for carriage rod or bar 20 on which carriage 22 translates back-and-forth in the directions of double-arrow 24 across print zone 26. Carriage 22 is driven by a belt 28 that is attached to a wheel 29 fixed to a rotating shaft 30 of motor 32 and wheel 31 rotatably mounted to a shaft 33. Four print cartridges 34, 36, 38, and 40 are removably mounted on carriage 22 and, in this example, include four different colors (cyan, magenta, yellow, and black) used for printing text and images. It is to be understood that other colors and different numbers of print cartridges may be used as well. Cartridges 34, 36, 38, and 40 may be accessed by an end user by lifting lid 17 when printing device 10 is not in use.

Another internal component shown in FIG. 1 is media advance roller 42 which is also supported by frame or chassis 18. Media advance roller 42 is rotatably driven by belt 44 that is attached to a wheel 45 fixed to a rotating shaft 46 of motor 48 and wheel 50 fixed to shaft 51 of media advance roller 42. Media advance roller 42 conveys print media (not shown) from tray 14 to print zone 26 where print cartridges 34, 36, 38, and 40 deposit ink onto the media to form text and images. From there, media advance roller 42 transports the print media to output shelf 52 for retrieval by an end user.

A rotary encoder 54 is fixed to an end of shaft 51 of media advance roller 42. Printing device 10 includes a sensor 56 that reads indicia or other markings (not shown in FIG. 1) of encoder 54 that indicate it's position which is read by sensor 56 and used by computing unit 58 to locate and track the advancement of print media in and through print zone 26. Computing unit 58 may include a microprocessor, controller, other electronics or a combination of any of these items. A non-transitory computer-readable storage medium 60 is connected to computing unit 58, as generally indicated by double-arrow 62, and includes machine readable instructions that are utilized by computing unit 58 to operate printing device 10. Non-transitory computer-readable storage medium 60 may include items such as firmware, a hard drive, etc. and may also store data recorded during operation of printing device 10 for use by computing unit 58.

Printing device 10 also includes an internal service station 62. Service station 62 includes a housing or base 64 that is attached to case or housing 12 of printing device 10 and a sled 66 movably mounted in housing 64, as discussed more fully below. During operation of printing device 10, printheads (not shown in FIG. 1) of print cartridges 34, 36, 38, and 40 and the individual nozzles thereof (also not shown) can become clogged or blocked with ink and other debris which can adversely affect the quality of text and images. Service station 62 includes wipers 68 and 70 that are mounted to sled 66 of service station 62 so as to be movable in the direction of translation of sled 66. Wipers 68 and 70 are made of a flexible or other compliant material and are shaped to help remove accumulated debris on these printheads as they move across them. This helps maintain the operation and life of print cartridges 34, 36, 38, and 40 and thus the overall print quality of printing device 10.

Service station 62 also includes a spittoon 72 designed to collect ink discharged through the nozzles of print cartridges 34, 36, 38, and 40 to help clear them of any clogs caused by things such as dried ink, dust or dirt. This also helps maintain the operation and life of print cartridges 34, 36, 38, and 40 and the overall print quality of printing device 10. Service station 62 additionally includes one or more caps, such as a cap 74, designed to fit over the nozzles of the printheads of print cartridges 34, 36, 38, and 40 during idle periods of non-use of printing device 10. Cap 74 helps prevent ink from drying in the nozzles and clogging them and also helps keep dirt and other debris from collecting on the printheads of print cartridges 34, 36, 38, and 40 which can degrade their operation as well as the overall print quality of printing device 10. Cap 74 may also include a mechanism designed to draw ink from the printhead nozzles of print cartridges 34, 36, 38, and 40 in an operation referred to as “priming” which can be used in some cases to help clear clogged nozzles or otherwise initiate or resume ink flow in one or more of print cartridges 34, 36, 38, and 40.

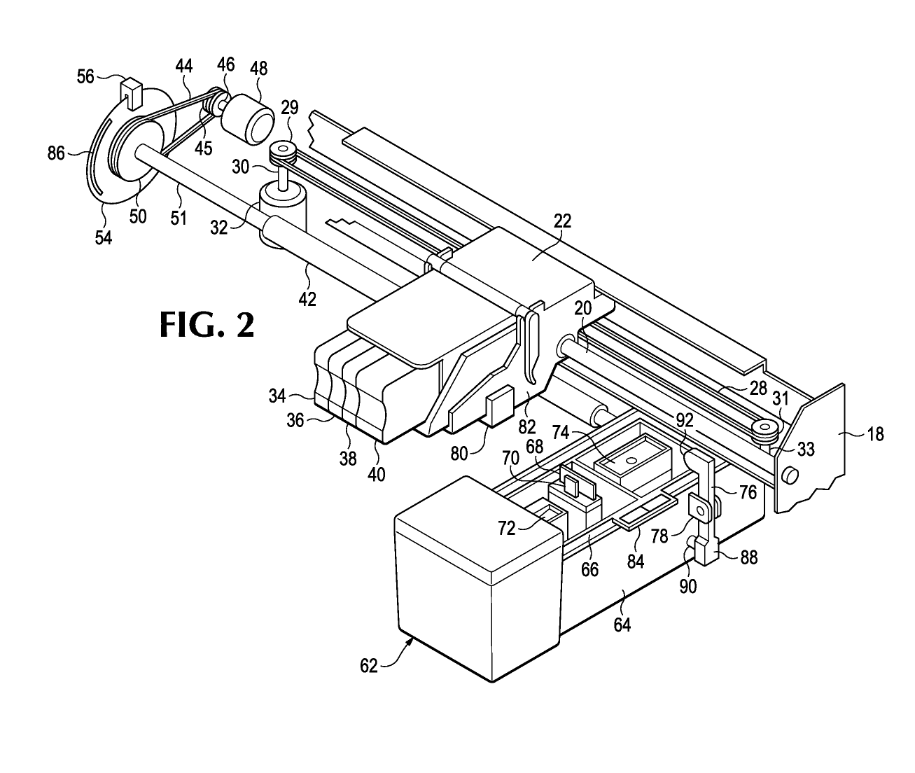

FIG. 2 shows a perspective view of an example of some of the components of printing device 10 in a first position. As can be seen in FIG. 2, printing device 10 also includes a lever 76 that is movably attached to service station housing 64 at pivot point 78. Printing device 10 additionally includes a sensor 80 mounted on a side 82 of carriage 22 and a target 84 attached to or otherwise associated with service station sled 66 so that translation of sled 66 also causes target 84 to move. Indicia or markings 86 on encoder 54 (discussed above in connection with FIG. 1) that are read by sensor 56 can also be seen in FIG. 2.

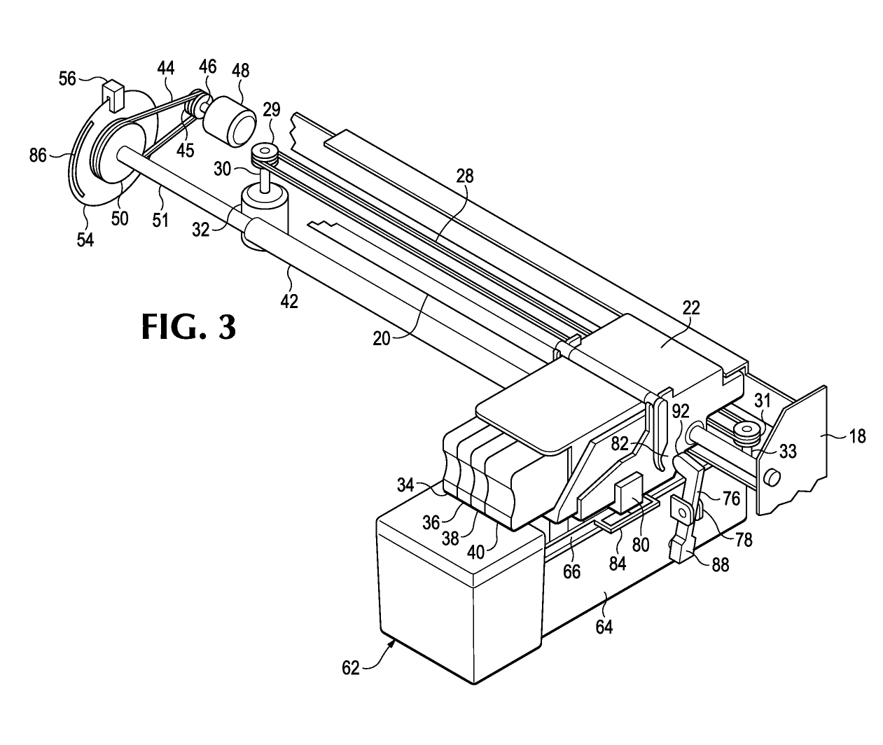

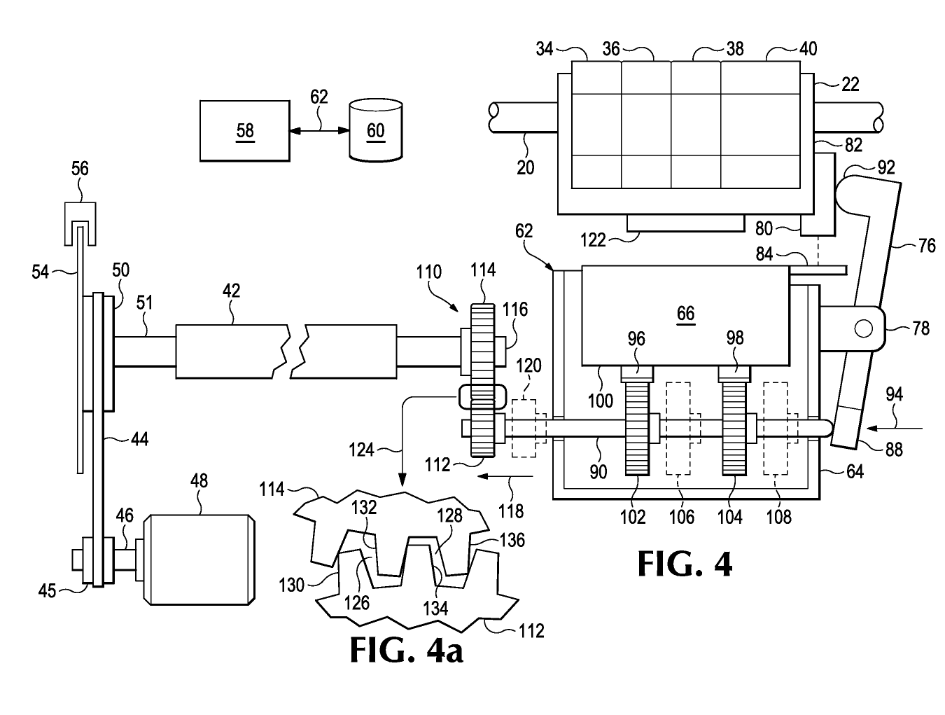

As can further be seen in FIG. 2, end 88 of lever 76 is positioned adjacent a displaceable shaft 90. As illustrated in FIG. 3, when carriage 22 is moved over service station 62, contact by side 82 of carriage 22 against end 92 of lever 76 causes end 88 to deflect toward shaft 90, in the direction generally indicated by arrow 94 in FIG. 4. This, in turn, also displaces shaft 90 in the direction generally indicated by arrow 94. Gear racks 96 and 98 are mounted to bottom 100 of service station sled 66 and are designed to mesh with gears 102 and 104 mounted on shaft 90 when it is displaced by end 88 of lever 76. Shaft 90 is biased so that gears 102 and 104 otherwise assume the positions generally indicated by respective outlines 106 and 108 when shaft 90 is not displaced by end 88 of lever 76 in the direction of arrow 94.

Gear racks 96 and 98 and gears 102 and 104 are components of a gear train assembly 110 of printing device 10. Gear train assembly 110 also includes an idler gear 112 mounted on shaft 90. Idler gear 112 is designed to mesh with drive gear 114 mounted on end 116 of shaft 51 of media advance roller 42 when shaft 90 is displaced by end 88 of lever 76 in the direction of arrow 118. Shaft 90 is also biased so that idler gear 112 otherwise assumes the position generally indicated by outline 120 when shaft 90 is not displaced by lever 76 in the direction of arrow 118.

As discussed above, when lever 76 is not engaged by side 82 of carriage 22, gears 102, 104, and 112 assume the position indicated by respective outlines 106, 108, and 120. This allows motor 48, rotary encoder 54, sensor 56, computing unit 58, and non-transitory computer-readable storage medium 60 to operate media advance roller 42 to convey print media through printzone 26. When lever 76 is engaged by side 82 of carriage 22, gears 102 and 104 mesh with respective gear racks 96 and 98. Idler gear 112 also meshes with drive gear 114 which imparts the rotational movement of shaft 51 of media advance roller 42 and gear 114 to idler gear 112. The rotational movement of idler gear 112 causes gears 102 and 104 to also rotate. Rotation of gears 102 and 104 in turn causes racks 96 and 98 to displace or translate service station sled 66.

The arrangement illustrated in FIG. 4 allows motor 48, rotary encoder 54, sensor 56, computing unit 58, and non-transitory computer-readable storage medium 60 to also displace or translate sled 66 of service station 62 so that printheads 122 of print cartridges 34, 36, 38, and 40 can be cleaned and maintained by wipers 68 and 70, spittoon 72, and cap 74, as discussed above in connection FIG. 1. This eliminates the need for a separate motor to control service station 62 which saves cost.

As generally indicated by arrow 124 and represented in the enlarged side-view of drive gear 114 and idler gear 112 in FIG. 4a, a certain amount of backlash or “play” exists in gear train 110. This is illustrated in FIG. 4a as spaces or gaps 126 and 128 between adjacent teeth 130, 132, 134, and 136 of meshed gears 112 and 114. This is a result of tolerance differences between gears 112 and 114 and can also occur in one or more of the other gears of gear train 110. The amount of backlash in gear train 110 needs to be determined and compensated for in order to accurately position the various components of service station 62 with respect to printheads 122 of print cartridges 34, 36, 38, and 40.

An exemplary way of determining and compensating for the backlash present in gear train 110 in accordance with the present invention includes the use of sensor 80 and target 84 as follows. Carriage 22 is first positioned over service station 62 so that lever 76 is deflected by side 82 and pivots about pivot point 78. This results in end 88 of lever 76 displacing shaft 90 in the direction generally indicated by arrows 94 and 118 in FIG. 4. This displacement causes gears 102 and 104 to mesh with respective gear racks 96 and 98 and idler gear 112 to mesh with drive gear 114. Drive gear 114 is then rotated in either a clockwise or counter-clockwise direction by motor 48, computing unit 58, etc. which causes idler gear 112 and shaft 90 to rotate in the same direction. This in turn causes gears 102 and 104 to rotate in the same direction and move respective gear racks 96 and 98 which displaces service station sled 66 in a first direction.

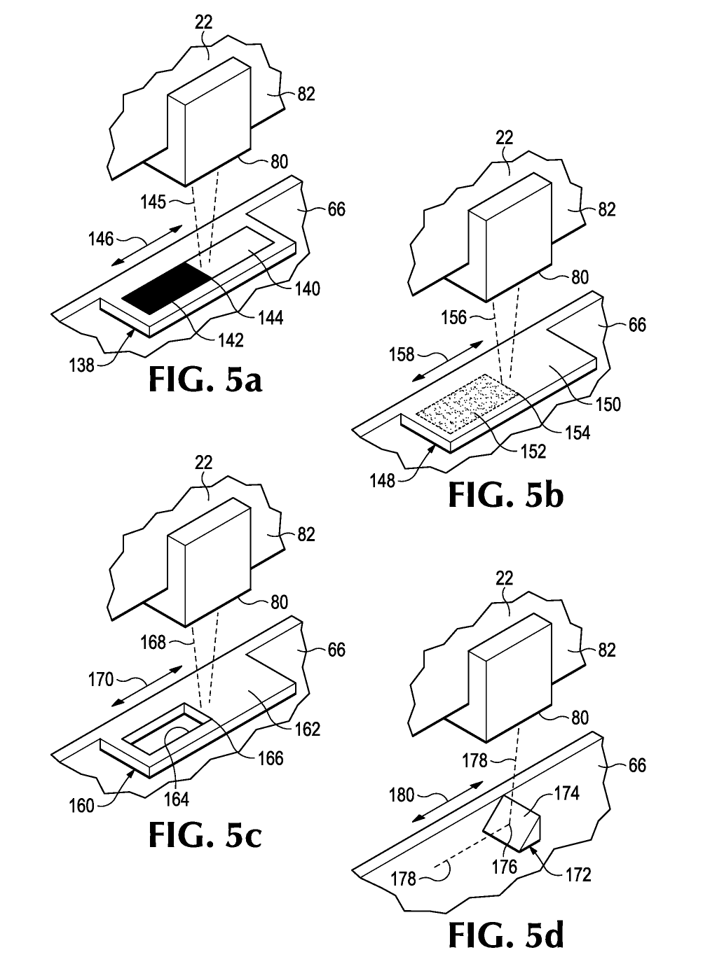

As discussed more fully below in connection with FIGS. 5a-5d, target 84, which is attached to and moves with service station sled 66, includes a transition detectable by sensor 80 positioned above it during displacement of service station sled 66 in the first direction. Upon detection of this transition, a first position of encoder 54, which rotates as drive gear 114 rotates, is detected by sensor 56 and recorded by computing unit 58. Next, drive gear 114 is rotated in the opposite direction by motor 48, computing unit 58, etc. which causes idler gear 112 and shaft 90 to now also rotate in that opposite direction. This in turn causes gears 102 and 104 to rotate in that same opposite direction and move respective gear racks 96 and 98 which displaces or moves service station sled 66 in an opposite second direction. Any backlash or “play” in gear train 110 occurs prior to the displacement or movement of service station sled 66 in the second direction. This backlash will be indicated by a second position of encoder 54, which rotates along with drive gear 114 of gear train 110. As service station sled 66 begins to move in the second direction, sensor 80 again detects the transition on target 84. Upon detection of this transition, the new position of encoder 54 is detected by sensor 56 and recorded by computing unit 58. Computing unit 58 is then able to calculate or determine the backlash in gear train 110 based upon the different first and second positions of encoder 54. The calculated or determined backlash can then be stored, for example, in non-transitory computer-readable storage medium 60. The value can be utilized to more accurately position service station 62 of printing device 10 when changing direction by adding the backlash value to the already known move distance.

Various examples of designs for target 84 are illustrated in FIGS. 5a-5d. More specifically, FIG. 5a shows a target 138 that includes a first portion 140 and a second portion 142 that is relatively darker than first portion 140. This creates or defines a transition 144 due to the different reflective characteristics or properties of first portion 140 and second portion 142. Sensor 80 emits light 145 toward target 138 and is designed to detect transition 144 as service station sled 66 is translated in either of the directions indicated by double arrow 146.

FIG. 5b shows another example of a target 148 that includes a first portion 150 and a second portion 152 that is relatively rougher than first portion 150. This creates or defines a transition 154 due to the different reflective characteristics or properties of first portion 150 and second portion 152. Sensor 80 emits light 156 toward target 148 and is designed to detect transition 154 as service station sled 66 is translated in either of the directions indicated by double arrow 158.

FIG. 5c shows an additional example of a target 160 that includes a first portion 162 and a second portion 164 that includes an aperture or opening. This creates or defines a transition 166 due to the reflective property of first portion 162 and the transmissive or non-reflective property of second portion 164. Sensor 80 emits light 168 toward target 160 and is designed to detect transition 166 as service station sled 66 is translated in either of the directions indicated by double arrow 170.

FIG. 5d shows a further example of a target 172 that includes a mirror 174 that creates or defines a transition 176 due to the different reflective characteristics or properties of mirror 174. Sensor 80 emits light 178 toward target 172 and is designed to detect transition 176 because of the deflection of light 178 and the resultant lack of returning light 178 at sensor 80 as service station sled 66 is translated in either of the directions indicated by double arrow 180.

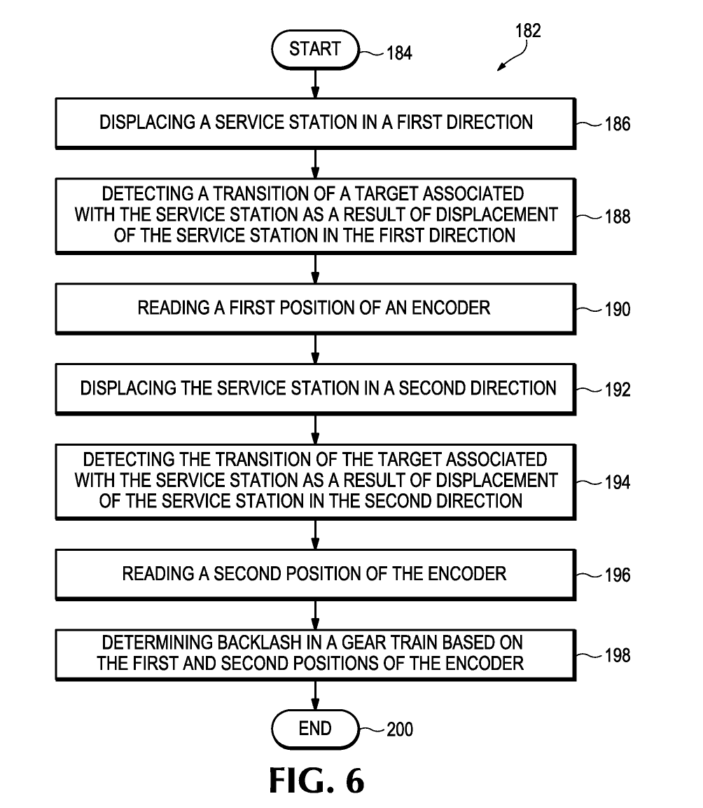

A block diagram and example of a method 182 for use in printing device 10 is shown in FIG. 6. Method 182 starts 184 by displacing a service station in a first direction, as generally indicated by block 186. Next, method 182 detects a transition of a target associated with the service station as a result of displacement of the service station in the first direction, as generally indicated by block 188. Method 182 next reads a first position of an encoder, as generally indicated by block 190, and then displaces the service station in a second direction, as generally indicated by block 192. Next, method 182 detects the transition of the target associated with the service station as a result of displacement of the service station in the second direction, as generally indicated by block 194. Method 182 then reads a second position of the encoder, as generally indicated by block 196, and determines backlash in a gear train based on the first and second positions of the encoder, as generally indicated by block 198. Method 182 may then end, as generally indicated by block 200.

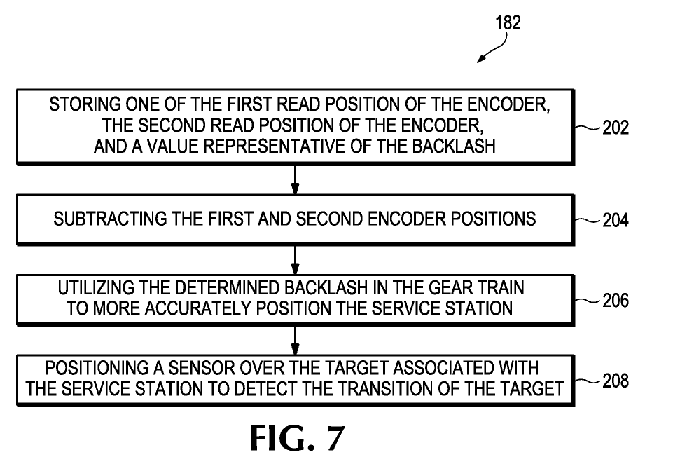

A block diagram and example of additional method 182 elements for use in printing device 10 is shown in FIG. 7. Method 182 may additionally include the element of storing one or more of the following: the first read position of the encoder, the second read position of the encoder, and a value representative of the backlash, as generally indicated by block 202. Method 182 may also include the element of subtracting the first and second encoder positions, as generally indicated by block 204, and/or the element of utilizing the determined backlash in the gear train to more accurately position the service station, as generally indicated by block 206. Method 182 may also additionally include positioning a sensor over the target associated with the service station to detect the transition of the target, as generally indicated by block 208.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. An apparatus for compensating for gear backlash associated with displacement of a service station, comprising:
a service station;
a target associated with the service station;
a first sensor that reads the target;
a gear train coupled to the service station so that movement of the gear train causes displacement of the service station;
an encoder associated with the gear train so that movement of the gear train causes a position of the encoder to change;
a second sensor that records a first position of the encoder upon detection of a transition of the target by the first sensor during displacement of the service station in a first direction by the gear train and records a second position of the encoder upon detection of the transition of the target by the first sensor during displacement of the service station in a second direction by the gear train; and
a computing unit that determines a backlash in the gear train based on the first and second positions of the encoder.

2. The apparatus of claim 1, further comprising a computer readable medium that stores one of the first position of the encoder recorded by the second sensor, the second position of the encoder recorded by the second sensor, and a value representative of the backlash determined by the computing unit.

3. The apparatus of claim 1, in a printing device.

4. The apparatus of claim 1, wherein the first sensor is mounted on a carriage of a printing device.

5. The apparatus of claim 1, wherein the target is on the service station.

6. The apparatus of claim 1, wherein the target includes a first portion that reflects light from the first sensor and a second portion that diffuses the light from the first sensor, and further wherein the transition is between the first portion and the second portion of the target.

7. The apparatus of claim 1, wherein the target includes a first portion that reflects light from the first sensor and a second portion that absorbs the light from the first sensor, and further wherein the transition is between the first portion and the second portion of the target.

8. The apparatus of claim 1, wherein the encoder is a media encoder.

9. A method for use in a printing device, comprising:
displacing a service station in a first direction;
detecting a transition of a target associated with the service station as a result of displacement of the service station in the first direction;
reading a first position of an encoder;
displacing the service station in a second direction;
detecting the transition of the target associated with the service station as a result of displacement of the service station in the second direction;
reading a second position of the encoder; and
determining backlash in a gear train based on the first and second positions of the encoder.

10. The method of claim 9, further comprising storing one of the first read position of the encoder, the second read position of the encoder, and a value representative of the backlash.

11. The method of claim 10, wherein one of the first position of the encoder, the second position of the encoder, and a value representative of the backlash are stored in a computer readable medium.

12. The method of claim 9, further comprising subtracting the first and second encoder positions.

13. The method of claim 9, further comprising utilizing the determined backlash in the gear train to more accurately position the service station.

14. The method of claim 9, further comprising positioning a sensor over the target associated with the service station to detect the transition of the target.

15. A non-transitory computer-readable storage medium storing instructions that, when executed by a processor, cause the processor to:
activate a gear train to move a service station in a first direction;
detect a transition of a target associated with the service station as a result of movement of the service station in the first direction;
determine a first position of an encoder;
activate the gear train to move the service station in a second direction;
detect the transition of the target associated with the service station as a result of movement of the service in the second direction;
determine a second position of the encoder; and
calculate backlash in the gear train based on the first and second positions of the encoder.

16. The non-transitory computer-readable storage medium of claim 15, further comprising stored instructions that, when executed by a processor, cause the processor to record one of the first determined position of the encoder, the second determined position of the encoder, and a value representative of the calculated backlash of the gear train.

17. The non-transitory computer-readable storage medium of claim 15, further comprising stored instructions that, when executed by a processor, cause the processor to subtract the first and second encoder positions.

18. The non-transitory computer-readable storage medium of claim 15, further comprising stored instructions that, when executed by a processor, cause the processor to utilize the determined backlash in the gear train to more accurately position the service station.

19. The non-transitory computer-readable storage medium of claim 15, further comprising stored instructions that, when executed by a processor, cause the processor to position a sensor over the target associated with the service station to detect the transition of the target.

20. The non-transitory computer-readable storage medium of claim 15, in a printing device.
